(19) United States
(12) Patent Application Publication
(10) Pub. No.: US 2003/0083104 A1
(43) Pub. Date: May 1, 2003

(54) Method and system for controlling a scanning beam in a point-to-multipoint (PMP) system

(76) Inventors: Michael Lohman, Germantown, MD (US); Tariq Muhammad, Gathersburg, MD (US); Tayyab Khan, Montgomery Village, MD (US); Yogesh Sethi, Gaithersburg, MD (US)

Correspondence Address: Hughes Electronics Corporation, Patent Docket Administration, Bldg. 1, Mail Stop A109, P.O. Box 956, EI Segundo, CA, 90245-0956, US

(21) Appl. No.: 10/002,067

(22) Filed: Oct. 30, 2001

(51) Int. Cl. H04M 1/00

(52) U.S. Cl. 455/562; 455/561; 455/11.1

(57) ABSTRACT

An approach is provided for communicating in a wireless network, such as a point-to-multipoint (PMP) system. A message that contains addressing information corresponding to one of the plurality of terminals is received by a radio terminal. The terminal electronically steers a beam of an antenna in response to the addressing information. The address information may also be used to specify the modulation type and coding level.

### FIELD OF THE INVENTION

The present invention relates to a radio communications system, and more particularly to providing point-to-multipoint communication.

### BACKGROUND OF THE INVENTION

Wireless communications systems provide a convenient approach to deploying a voice and data infrastructure. With the advances in signal processing and communications technologies, the bandwidth and performance of such wireless systems rival that of terrestrial networks. Because wireless systems can be rapidly and cost-effectively deployed, such systems have enabled service providers to enter the broadband access market with minimal capital investment. However, wide spread implementation of wireless systems, particularly in metropolitan areas, has been hindered by the limited performance and range of the radio terminals. One key factor that influences performance is the ability of the radio terminals to maximize signal strength by properly directing the antenna beam, in a narrow beam focused on a single terminal, at any give instant in time

Conventional approaches to directing antenna beams rely on software control. However, such approaches have resulted in substantial complexity in the software, which has difficulty managing the real-time parameters associated with steering an antenna. Another drawback of the conventional system is that such software is extremely slow, and inefficient.

Therefore, there is a need for an approach to efficiently and rapidly direct an antenna beam of a radio terminal.

### SUMMARY OF THE INVENTION

These and other needs are addressed by the present invention, which provides an approach for using address information within a message to direct a scanning beam antenna to point to the correct destination angle. The present invention advantageously simplifies real-time software control, and enhances the efficiency and response time of the system. In addition, this approach can also be used to direct modulation scheme and coding level.

According to one aspect of the present invention, a method is provided for communicating in a wireless network having a plurality of terminals. The method includes receiving a message that contains addressing information corresponding to one of the plurality of terminals. Additionally, the method includes electronically steering a beam of an antenna in response to the addressing information.

According to another aspect of the present invention, an apparatus is provided for communicating in a wireless network. The apparatus includes an interface that is configured to receive a message that contains addressing information corresponding to a terminal within the wireless network. The apparatus also includes an antenna that has a beam and is configured to transmit the message. Further, the apparatus includes logic that is configured to electronically steer the beam of the antenna in response to the addressing information.

According to another aspect of the present invention, an apparatus is provided for communicating in a wireless network. The apparatus includes means for receiving a message that contains addressing information corresponding to a terminal within the wireless network. The apparatus also includes means for electronically steering a beam of an antenna in response to the addressing information.

According to another aspect of the present invention, a radio communications system is provided. The system includes a terminal that is configured to receive a message from a host. The message contains addressing information corresponding to another terminal. The terminal includes an antenna that has a beam that is electronically steered in response to the addressing information.

In yet another aspect of the present invention, a computer-readable medium carrying one or more sequences of one or more instructions for communicating in a wireless network having a plurality of terminals is disclosed. The one or more sequences of one or more instructions includes instructions which, when executed by one or more processors, cause the one or more processors to perform the step of examining a message that contains addressing information corresponding to one of the plurality of terminals. Another step includes initiating electronic steering of a beam of an antenna in response to the addressing information.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communications system that utilizes a point-to-multipoint (PMP) radio network, according to an embodiment of the present invention;

FIG. 2 is a diagram of a radio terminal used in the PMP radio network of FIG. 1;

FIG. 3 is a diagram of an exemplary implementation of an indoor unit (IDU) of a radio terminal, according to an embodiment of the present invention;

FIGS. 4a and 4b are, respectively, a diagram of a message having a data structure that includes addressing information and a diagram of an exemplary message that includes an Asynchronous Transfer Mode (ATM) cell with a prepended tag, according to various embodiments of the present invention;

FIG. 5 is a diagram of an exemplary implementation of a radio terminal that is capable of directing an antenna beam, according to an embodiment of the present invention;

FIG. 6 is a flow chart of a process for directing an antenna beam based upon addressing information, according to an embodiment of the present invention; and

FIG. 7 is a diagram of a computer system that can be used to implement an embodiment of the present invention.

### DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is discussed with respect to the Asynchronous Transfer Mode (ATM) protocol and a point-to-multipoint system, it is recognized that the present invention has applicability to other communications protocols, such as the Internet Protocol, proprietary tagging, VLAN (IEEE 802.1) and radio communications systems, in general.

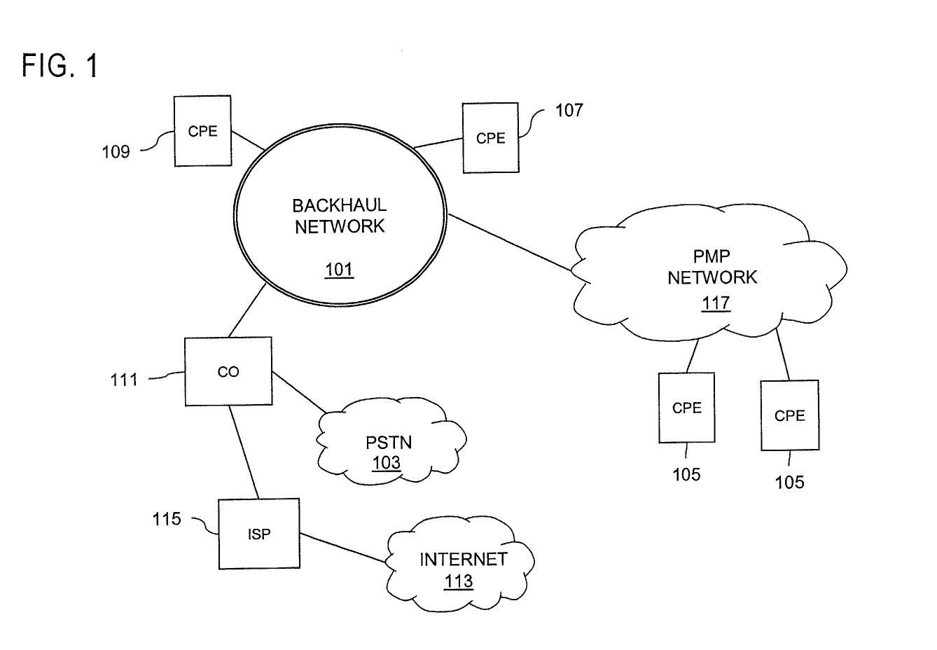

FIG. 1 shows a diagram of a communications system that utilizes a point-to-multipoint (PMP) radio network, according to an embodiment of the present invention. A communications system 100, in an exemplary embodiment, may be deployed in a metropolitan environment in which a backhaul network 101 (e.g., fiber network, point-to-point microwave network, and etc.) carries traffic from the public switched telephone network (PSTN) 103 to a number of customer premise equipment (CPE) 105, 107, 109. A central office (CO) 111 originates traffic from the PSTN 103 as well as the Internet 113, to which the CO 111 is connected via an Internet Service Provider (ISP) 115.

In this example, the CPE 105 has connectivity to a PMP network 117. The PMP network 115, which operates in the microwave frequency range, is a wireless network that transports traffic to and from the fiber optic network 101. Within the PMP network 117 are a number of terminals that are configured to electronically steer antenna beams based upon messages that are received from hosts (not shown).

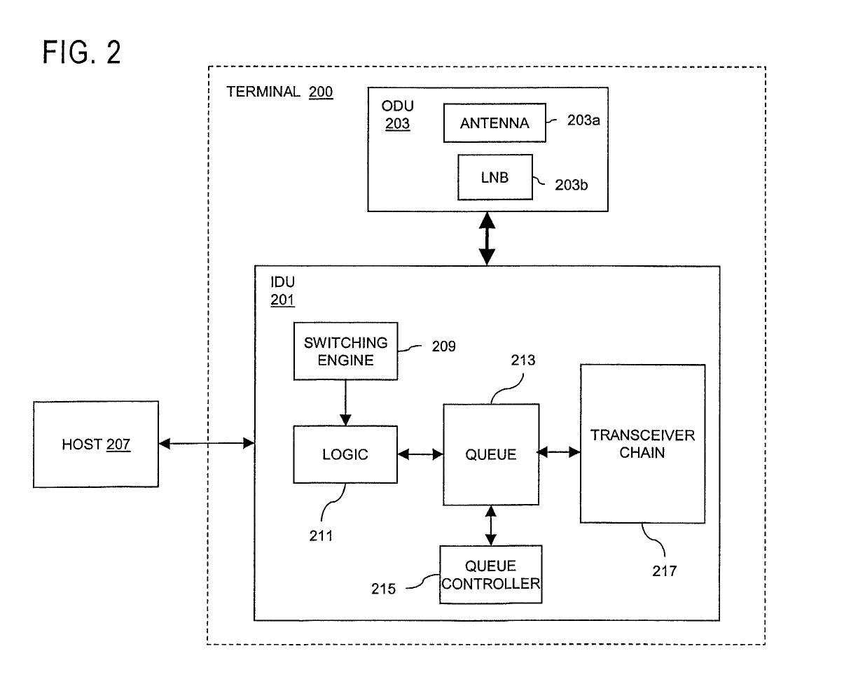

FIG. 2 shows a diagram of a radio terminal used in the PMP radio network of FIG. 1. In an exemplary embodiment, a terminal 200 includes an indoor unit (IDU) 201 and an outdoor unit (ODU) 203. The ODU 203 has an antenna 203a and a Low Noise Block (LNB) 203b for transmission and reception of signals to the IDU 201. The antenna 203a, in an exemplary embodiment, is a scanning beam antenna, in which the beam is electronically controlled by the IDU 201 through the ODU 203, 205. The ODU 203, 205 connects to the IDU 201 over an inter-facilities link (IFL) cable 205, which may be optical.

Through the IDU 201, the terminal 200 provides connectivity to a wireless network for a host 207, which may be any computing system (e.g., personal computer, workstation, etc.) or a network device, such as a router. The host may be connected to the IDU 201 through the backhaul network 101. Although a single host 207 is shown, it is recognized that a number of hosts may be utilized. The terminal 200 forwards messages from the host 207 to a destination terminal (not shown), which in turn, relays the messages to another host (not shown) to which the originating host 207 specifies. This transaction requires that the terminal 200 determine the proper destination terminal and transmit signals that are representative of the messages from the host 207 over a wireless link with good channel characteristics. The channel characteristics are affected, among other factors, by the direction of the antenna beam from the terminal 200 to the destination terminal. For successful transmission, the beam of the antenna 203a must be directed to the correct angle at the correct time to transmit and receive bursts from the destination terminal.

Conventionally, control of the direction of the beam of a scanning beam antenna is not easily performed. As a result, the IDU 201 has the capability to electronically steer the antenna 203a in response to the data packets that are received from the host 207. In other words, the terminal 200, according to an embodiment of the present invention, utilizes the address information within the data itself to direct the scanning beam antenna 203a to point to the correct destination angle on a packet by packet basis. Accordingly, real-time software control is greatly simplified. Also, the efficiency and response time of the wireless system is enhanced. Furthermore, this approach can also be used to direct the modulation scheme as well as the coding level of the terminal 200.

As shown, the IDU 201 includes a switching engine 209, which in an exemplary embodiment is an ATM engine. Alternatively, the switching engine 209 may be IP (Internet Protocol) based; e.g., an IP router, or VLAN based, or any packet queuing based system. The ATM engine 209 couples to logic 211 that permits messages to be stored in a queue 213 for transmission. A queue controller 215 is used to monitor and control the status of the queue 213. The messages that are stored within the queue 213 are forwarded to a transceiver chain 217 for transmission via the antenna 203a. The queue controller 215 manages the queue 213 by taking into account all customer service level agreements (SLA's), which may be configured on a per connection basis. Each connection is given fair access to the air bandwidth based on the SLA. Each SLA, in an exemplary embodiment, includes the following parameters: on peak bandwidth allowed, and a minimum bandwidth guarantee.

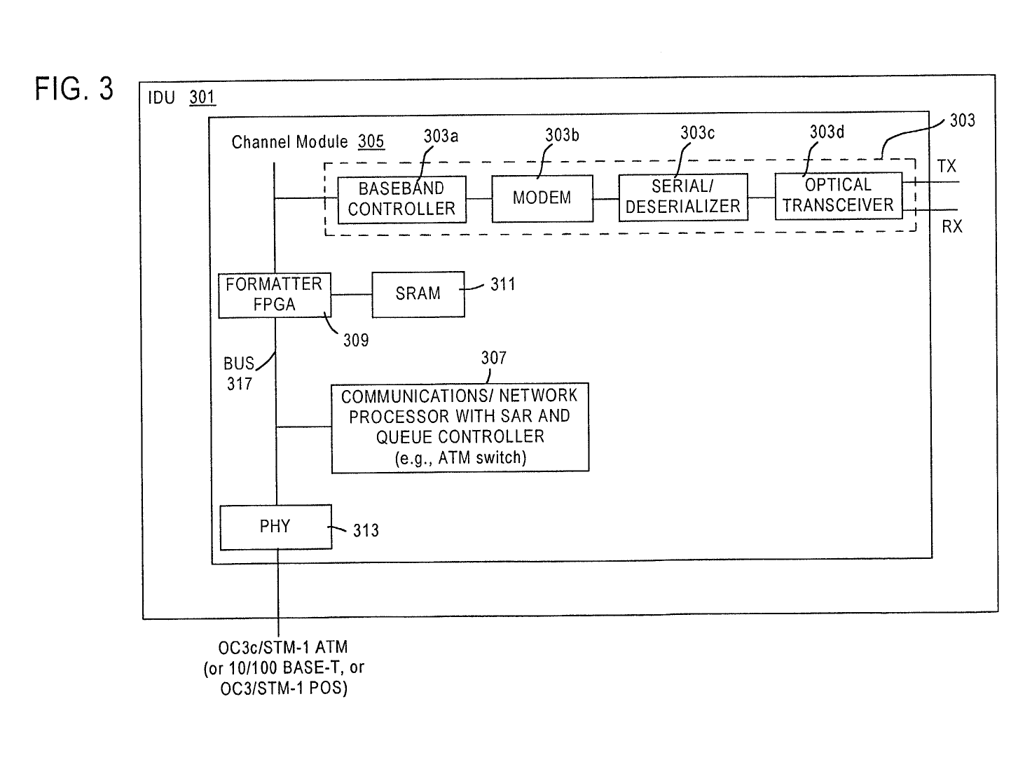

FIG. 3 shows a diagram of an exemplary implementation of an indoor unit (IDU) of a radio terminal, according to embodiments of the present invention. An IDU 301, in an exemplary embodiment, has a transceiver chain 303, which is located on a channel module 305. The transceiver chain 303 includes a baseband controller 303a, a digital modem 303b, a serial/deserializer 303c, and an optical transceiver (i.e., transmitter/receiver) 303d. The channel module 305 also includes, in an exemplary embodiment, a communications (or network) processor 307; the processor 307 may include a segmentation reassembly (SAR) function as well as act as a queue controller. The communications processor 307, according to one embodiment of the present invention, is an Asynchronous Transfer Mode (ATM) switch 307. Additionally, the channel module 305 includes a formatter Field Programmable Gate Array (FPGA) 309, and static Random Access Memory (RAM) 311. The channel module 305 also has a PHY (physical layer) interface 313, which, in an exemplary embodiment, supports an ATM OC (Optical Carrier)-3c (concatenated)/STM (Synchronous Transport Module)-1 rate. . Alternatively, the PHY interface 313 may be an Ethernet interface (e.g., 10/100 Base-T) or a Packet Over Sonet (POS) OC-3/STM-1. The SRAM 311 may be used to implement the queues of the present invention. The formatter FPGA 309 is more fully described below. The formatter FPGA 309 interfaces with the baseband controller 303a and the ATM switch 307 via a bus 317 (e.g., a Utopia-2 bus). The formatter FPGA 309 processes the ATM cells for transmission; specifically, the FPGA 309 formats the ATM cells, along with the beam direction information into air bursts. The formatter FPGA 309 uses the SRAM 311 as the queues for temporary storage of the ATM cells and storage of the timeplan.

The PHY interface 313 can also process IP packets. The packets may be segmented by the communications processor 352, in which the segments are queued by a queuing engine (not shown) in the communications processor 352.

The ODU interface block (not shown), in an exemplary embodiment, uses a fiber optic link between the ODU and IDU, as discussed in FIG. 2. The link between the ODU and IDU may alternatively be a coax cable.

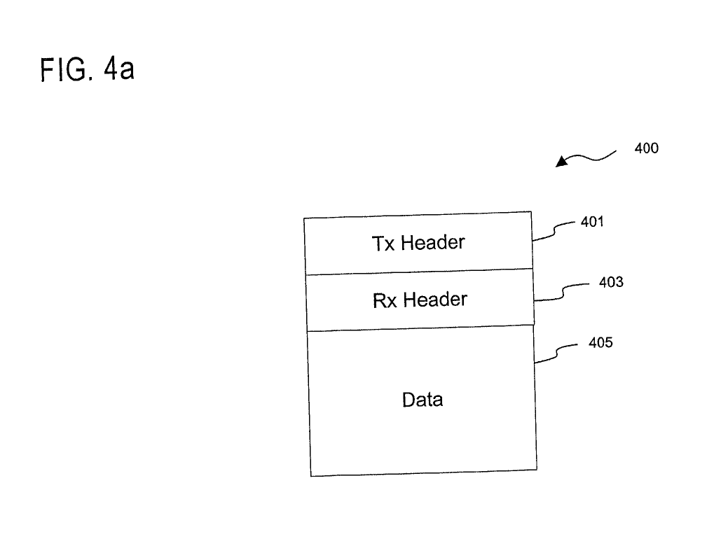

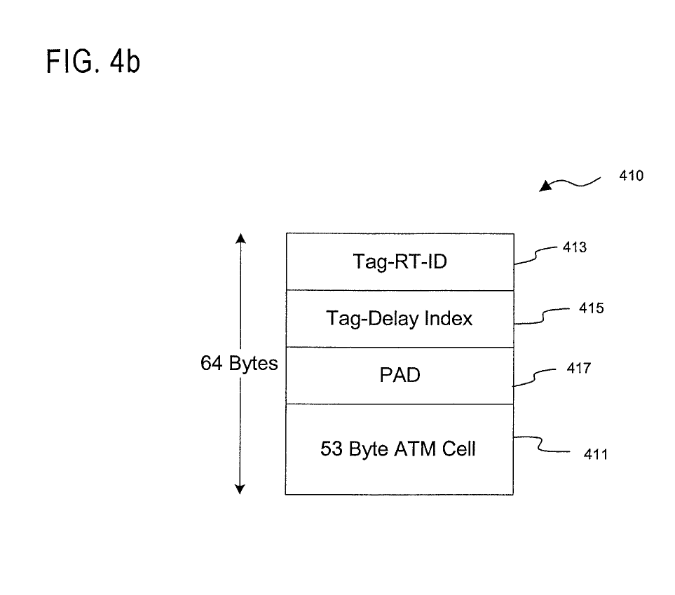

For the purposes of explanation, the operation of the IDU 301 is described with respect to a point-to-multipoint (PMP) system in which an ATM engine is deployed. As mentioned previously, the IDU 301 receives messages from a connected host (FIG. 2) and utilizes the messages to direct a scanning beam angle associated with an antenna of the terminal. The messages contain data packets that possess addressing information, as described in FIG. 4.

FIGS. 4a and 4b show, respectively, a diagram of a message having a data structure that includes addressing information and a diagram of an exemplary message that includes an Asynchronous Transfer Mode (ATM) cell with a prepended tag, according to various embodiments of the present invention. As shown in FIG. 4a, a message 400 includes a transmit (Tx) header field 401, a receive (Rx) header field 403, and a data field 405. The Tx header field 401 specifies the angle of a transmit beam for the particular data field 405. The Rx header field 403 indicates the angle of receive beam for the next receive air burst. The message 400, according to one embodiment of the present invention, may include an ATM cell, as shown in FIG. 4b.

An ATM message 410 includes a 53 byte ATM cell 411, which is output from a host (e.g., host 207). Effectively, a TAG is prepended to the ATM cell 411; the TAG, which in an exemplary embodiment is 11 bytes in length, includes the following fields: a TAG-RT-ID (TAG remote terminal identification) field 413, a TAG-Delay Index field 415, and a PAD (padding) field 417.

The 64 byte message 410 provides the IDU 301 with information to steer the beam. The ATM cell 411 has a 5 byte header that includes a VP (Virtual Path) identifier and VC (Virtual Circuit) identifier, which collectively provides a connection identifier that is unique for each connection between an originating terminal and a destination terminal. The VP/VC is translated to a TAG-RT-ID, which is used to direct the angle of the beam on the transmit antenna and is stored in a TAG-RT-ID field 413. The PAD field 417 permits bit stuffing to attain a fixed length of 64 bytes.

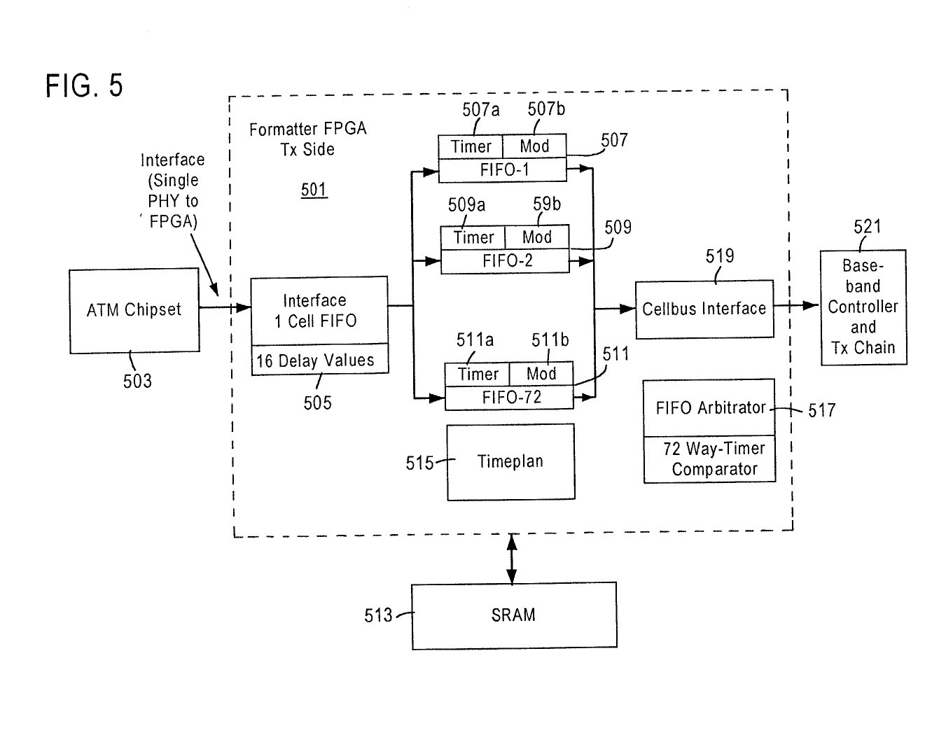

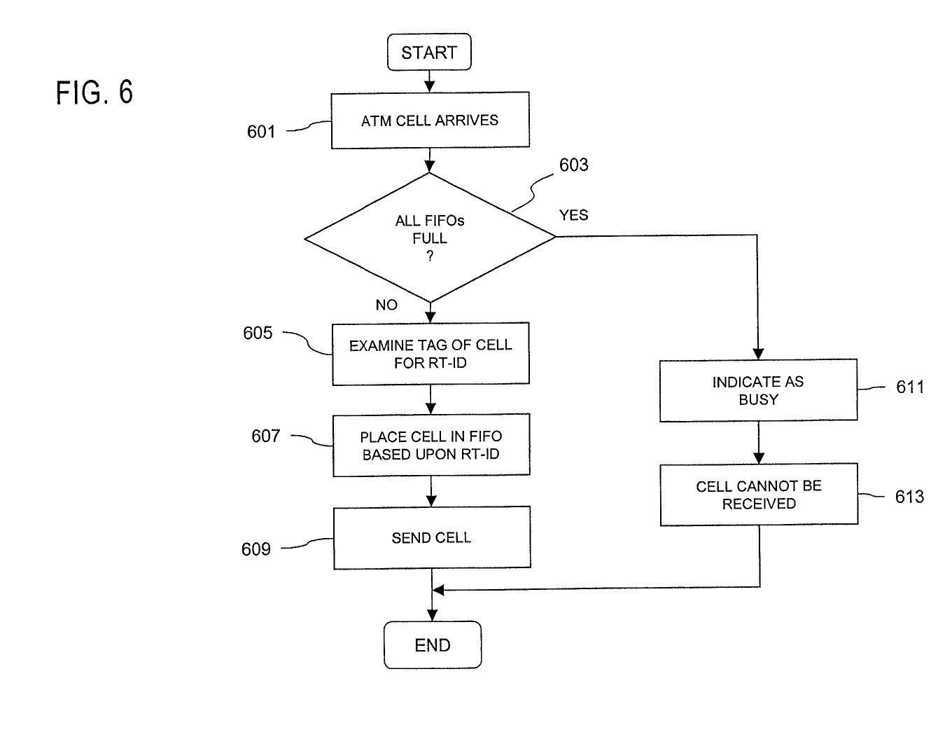

The delay index part of the TAG (TAG-Delay Index field 415) is used to extract the delay-value in a preconfigured delay-value table that is maintained by the IDU 301. The delay-value, in an exemplary embodiment, includes a 4 bit number, from 0 to 15, that correspond to 1 to 12 msec linearly; this delay value is the maximum delay allowed for the cell to maintain a certain Quality of Service (QoS)—which is often used as a Service Level Agreement (SLA) parameter. For instance, a constant bit rate (CBR) connection will likely have a lower value, such as 2 msec, while an unspecified bit rate (UBR) may have a longer value, such as 12 msec. It is noted that the VP/VC may be translated to a TAG that is used to specify the modulation scheme and coding level of the burst. Returning to the diagram of FIG. 2, logic 211 utilizes the TAG-RT-ID field 413 to collect multiple ATM cells that belong to the same destination angle, while still guaranteeing the QoS. The control of the beam involves controlling the direction of the beam, and determining when to direct the beam to which angle to guarantee fair and efficient traffic usage of the air bandwidth. This control mechanism is further described with respect to FIGS. 5 and 6. It is noted that the above processes may also be performed in software, but may be relatively slower than a hardware implementation, as next discussed. Moreover, a slower implementation may result in wasted air bandwidth.

When implemented in hardware, the communications network processor 307 (FIG. 3) may be an ATM chipset, which performs ATM prioritization, and collects the ATM cells into groups of a pre-determined amount. This amount may correspond to an air burst; for example, four cells may be employed as an air burst constitutes four cells. To make the wireless system operate the same with or without the scanning beam antenna feature of the present invention, all bursts are formatted this way, regardless of the antenna type. This has the benefit of providing the ability to change the modulation type of any one terminal at any time without making timeplan updates at all. The terminal changes the timeplan map on the channel module 305, according to one of a multitude of modulation schemes that is supported by the terminal.

The ATM engine 307 makes a decision on the highest priority cell on a cell by cell basis. If, for example, air bursts are approximately 8 microseconds, the ATM chipset can respond to changing traffic demand with 8 microseconds; consequently, fewer wasted air bandwidth results. Therefore, the present invention greatly reduces the software complexity to implement the scanning beam feature. In addition, the present invention advantageously provides more responsive and efficient wireless system.

FIG. 5 shows a diagram of an exemplary implementation of a radio terminal that is capable of directing an antenna beam, according to an embodiment of the present invention. As seen in the figure, an Formatter field programmable gate array (FPGA) 501 processes ATM cells from an ATM chipset 503. For explanatory purposes, the transmit side of the FPGA 501 is described. The ATM chipset 503 prioritizes the ATM cells and interfaces with the Formatter FPGA 501. According to one embodiment of the present invention, the FPGA 501 “aligns” the ATM traffic into a time division multiple access (TDMA) air interface frame. With the scanning beam feature, each burst is sent to a single terminal. Because the air interface uses quad bursts, four ATM cells for the same terminal is collected and formatted into a quad air burst. In an alternative embodiment, N cells are collected, where n=1 to 32 or more. It is also possible that 64 byte or 72 bytes or larger cells are used instead of 53 byte ATM cells.

The FPGA 501 contains an interface 505 that couples to multiple FIFO (First In First Out) queues 507, 509, 511. Each of the queues 507, 509, 511 has a timer block 507a, 509a, 511a and a modulation (Mod) register 507b, 509b, 511b. As noted in the figure, the FIFO queues 507, 509, 511 may be implemented in an external memory (e.g., SRAM (Static Random Access Memory)) 513; each of the FIFO queues 507, 509, 511 may store four ATM cells. A timeplan 515 may specify the following entries: timeslot, modulation and coding type, and destination angle.

The FIFO queues 507, 509, 511 are arbitrated by a FIFO arbitrator 517 (which represents an embodiment of logic 211 of FIG. 2), which may use a multiple timer comparator, which corresponds to the number of FIFO queues 507, 509, 511. In this example, the number of FIFO queues 507, 509, 511 is 72. The FIFO arbitrator 517 selects the FIFO queue 507, 509, 511 from which the next air burst is to be filled with data (i.e., ATM cells). Each FIFO queues 507, 509, 511 corresponds to a remote terminal (RT). Once a FIFO queue 507, 509, 511 is selected, an air burst is formatted using data from the selected FIFO queue 507, 509, 511.

As mentioned, in an exemplary embodiment, an air burst encompasses four ATM cells (i.e., 212 bytes); alternatively, 16 ATM cells may be used to create an air burst. The air burst is formatted according to the data structure of FIG. 4a, in which a Transmit header field 401 storea and an index that alerts the ODU 203 of the angle to transmit the beam on. This airburst is sent on a fiber link to the ODU 203, which then transmits the data over the air in the direction as indicated by the Tx header field 401. It is noted that a time plan is not necessary for this process.

As seen in FIG. 5, the FPGA 501 also provides a cellbus interface 519 to a baseband controller and transmit chain 521. The operation of the FPGA 501 is discussed below with respect to FIG. 6.

FIG. 6 shows a flow chart of a process for directing an antenna beam based upon addressing information, according to an embodiment of the present invention. In step 601, an ATM cell enters the interface 505 of the FPGA 501 from the ATM chipset 503. The cell is guaranteed to be the highest priority cell at the time (or in accordance with all SLA's) the cell is sent to the FPGA 501 by the ATM chipset 503. Next, in step 603, the FIFO queues 507, 509, 511 are checked to determine whether the queues 507, 509, 511 are full. The ATM chipset 503 is only allowed to send a cell if all 72 FIFO queues 507, 509, 511 are not full; that is, if a queue 507, 509, 511 is available. In another embodiment, the ATM chip set 503 can poll each FIFO queue 507, 509, 511 using a Utopia-2 bus (not shown), and send ATM cells to any FIFO queue 507, 509, 511 that is not full.

The ATM cell arrives with a TAG (as described in FIG. 4) prepended by the ATM Chipset 503. Each VP/VC has a 16-bit tag value that is configured at the time of the connection setup. The first byte of the TAG is the RT-ID for the VP/VC and the second byte has a 4 bit value that is an index into the delay table. If the queues 507, 509, 511 are not full, the prepended TAG of the ATM cell, as in step 605, is examined. If any FIFO queues 507, 509, 511 is full, then the interface 505 of the FPGA 501 responds to the polls from the ATM Chipset 503 that the FPGA 501 is busy (not ready) and cannot receive a cell, per steps 611 and 613, respectively; this mechanism is referred to as “backpressure.”

In step 607, the FPGA 501 receives the ATM cell, and places the cell directly into the FIFO queue corresponding to the RT-ID; according to one embodiment of the present invention, there is one FIFO queue for each RT-ID. The delay value, as specified by the TAG-Delay Index field 405, is sent to the FIFO Timer block 507a, 509a, 511a, which contains a running count-down timer. If the new delay-value is less than the current value of the timer, then the timer is loaded with the new delay value.

Next, the FIFO queues 507, 509, 511 are selected to be emptied to send their cells to the baseband controller 521, as in step 609. For the cell to be sent, two conditions need to be satisfied. The first condition may be any one of the following scenarios: (a) the FIFO Timer 507a, 509a, 511a expires, (b) the FIFO queue 507, 509, 511 is filled with four cells, and (c) the air interface has an idle slot and a FIFO is not empty. Condition (a) takes precedence over conditions (b) and (c). If more than one FIFO expires at the same time, then a round robin scheme may be used; in an exemplary embodiment, the fullest FIFO queue 507, 509, 511 is emptied first. If more than one FIFO queue 507, 509, 511 is full at the same time, then the FIFO queue 507, 509, 511 with the lowest timer value is selected. If more than one has the same counter value, then a round robin scheme is used. If more than one FIFO queue 507, 509, 511 is not empty, then the FIFO queue 507, 509, 511 with the lowest timer value is selected. If more than one has the same counter value, then the fullest FIFO queue 507, 509, 511 is selected. If more than one FIFO queue 507, 509, 511 has the same fill level, then a round robin scheme is used. Alternatively, it is noted that the fullest FIFO queue 507, 509, 511 may be sent first, regardless of timer value, as long as the timer has not expired.

The second condition that has to met is that the Mod register must match the permissible modulation scheme (or type) for the current timeslot. The allowed modulation types are constrained by the alignment of the timeslot groups. The modulation type of the FIFO queue 507, 509, 511 is located in the Mod register associated with each FIFO queue 507, 509, 511. The modulation type is determined at the time of RT installation and is based on the link margin. The modulation can change over time depending on, for example, weather conditions; in particular, the modulation type is changed by changing the stored value within the Mod register (this may be accomplished via software).

In an exemplary embodiment, the air interface is divided into 57 timeslot groups. A group may be as follows: one QPSK (Quadrature Phase Shift Keying) Quad Burst, two 16-QAM (Quadrature Amplitude Modulation) quad bursts, or three 64-QAM quad bursts. The modulation of the entire timeslot group is dictated by the FIFO queue 507, 509, 511 that is selected at the very start of the timeslot group. For example, if a FIFO queue 507, 509, 511 for 64 QAM is selected, then the next two FIFO queues 507, 509, 511 that get selected must also be for 64-QAM. If the FIFO queue 507, 509, 511 is associated with 16-QAM, then the next FIFO queue 507, 509, 511 must be for 16 QAM. If the FIFO queue 507, 509, 511 is for QPSK, then there is no restriction on the next FIFO queue 507, 509, 511. The reason for this is that the terminals are configured to listen to one modulation type only; it is assumed that the air bursts are all aligned to the 57 timeslot groups, and are all of their modulation. If a 64-QAM burst in slot 1 is followed by a 16-QAM burst, the terminal listening for the 16-QAM burst would not receive it, since the terminal would be searching for the synchronization (sync) word at the wrong time.

Once a FIFO queue 507, 509, 511 is selected, all of the cells in the FIFO queue 507, 509, 511 are sent to the baseband controller. The RT-ID TAG and the modulation type is sent with each cell. If there are less than 4 cells, then idle cells are inserted. It is noted that no FIFO queue 507, 509, 511 is selected unless there is an available timeslot in the timeplan. If a timeslot is marked as not available for ATM, then all FIFO queues 507, 509, 511 must wait. A timeslot may be used for time division multiplexing (TDM), and thus, not be available for ATM.

According to an embodiment of the present invention, the timeplan is also used, as a “hybrid” mode. Under this scenario, some entries in the timeplan indicate a specific FIFO queue 507, 509, 511 for that time slot. The FIFO arbitrator 517 first reads the timeplan, and if the timeslot is marked for a specific FIFO queue 507, 509, 511 then that FIFO queue 507, 509, 511 is automatically selected, regardless of the state of the other FIFO queues 507, 509, 511 or the timers. If the selected FIFO queue 507, 509, 511 from the timeplan is empty, or if the timeslot in the timeplan is not dedicated to a certain FIFO queue 507, 509, 511, then the FIFO selection process, as described previously, is used. The system can also run in another mode, such that the timeplan is ignored at all times. The hybrid mode is useful to guarantee a certain number of timeslots to each RT.

The receive direction does not involve the FIFO arbitrator 517. Instead, the receive timeplan, which contains the angle of the receiving antenna beam, is configured via software. The receive angle is sent to the ODU 203 in the header of the Tx packet that precedes in time the next receive air burst.

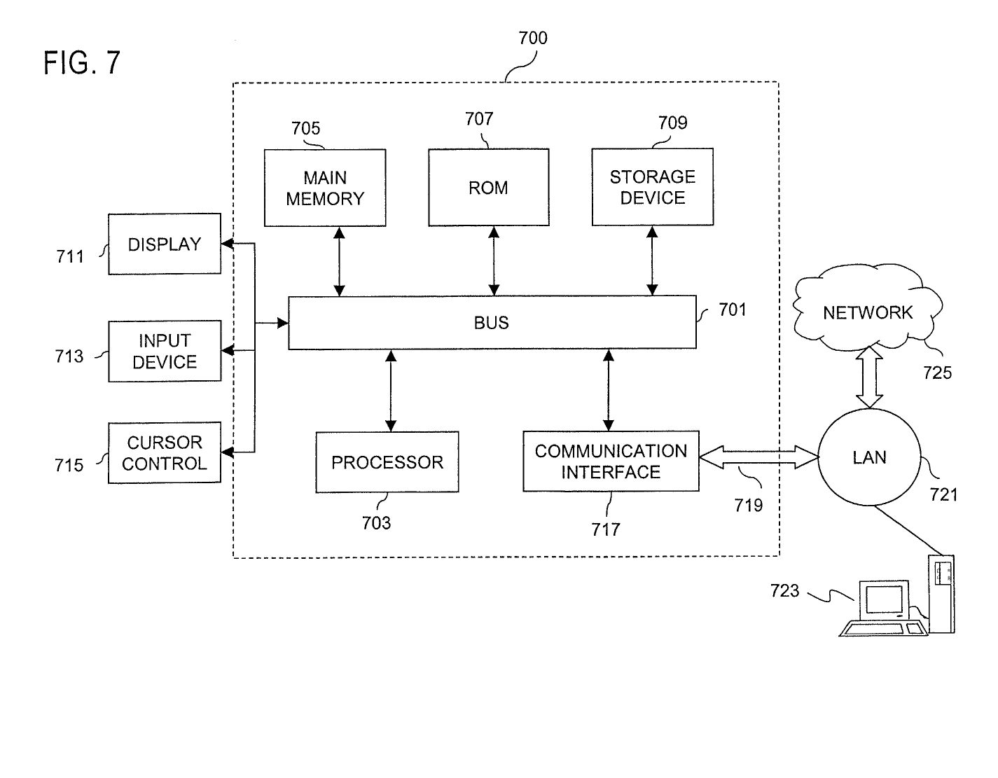

FIG. 7 illustrates a computer system 700 upon which an embodiment according to the present invention can be implemented. The computer system 700 includes a bus 701 or other communication mechanism for communicating information, and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions to be executed by the processor 703. The computer system 700 further includes a read only memory (ROM) 707 or other static storage device coupled to the bus 701 for storing static information and instructions for the processor 703. A storage device 709, such as a magnetic disk or optical disk, is additionally coupled to the bus 701 for storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is cursor control 715, such as a mouse, a trackball, or cursor direction keys for communicating direction information and command selections to the processor 703 and for controlling cursor movement on the display 711.

According to one embodiment of the invention, the process of FIG. 6 is provided by the computer system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the present invention. Thus, embodiments of the present invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, or a telephone modem to provide a data communication connection to a corresponding type of telephone line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by service provider. The local network 721 and network 725 both use electrical, electromagnetic, or optical signals to convey information and instructions. The signals through the various networks and the signals on network link 719 and through communication interface 717, which communicate digital data with computer system 700, are exemplary forms of carrier waves bearing the information and instructions.

The computer system 700 can send messages and receive data, including program code, through the network(s), network link 719, and communication interface 717. In the Internet example, a server (not shown) might transmit requested code belonging an application program for implementing an embodiment of the present invention through the network 725, local network 721 and communication interface 717. The processor 705 may execute the transmitted code while being received and/or store the code in storage device 79, or other non-volatile storage for later execution. In this manner, computer system 700 may obtain application code in the form of a carrier wave.

The term “computer-readable medium” as used herein refers to any medium that participates in providing instructions to the processor 705 for execution. Such a medium may take many forms, including but not limited to non-volatile media, volatile media, and transmission media. Non-volatile media include, for example, optical or magnetic disks, such as storage device 709. Volatile media include dynamic memory, such as main memory 707. Transmission media include coaxial cables, copper wire and fiber optics, including the wires that comprise bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, an approach for using address information within a message to direct a scanning beam antenna to point to the correct destination angle and to specify modulation scheme and coding level. The present invention advantageously simplifies real-time software control, and enhances the efficiency and response time of the system.

While the present invention has been described in connection with a number of embodiments and implementations, the present invention is not so limited but covers various obvious modifications and equivalent arrangements, which fall within the purview of the appended claims.

What is claimed is:

1. A method for communicating in a wireless network having a plurality of terminals, the method comprising:
receiving a message that contains addressing information corresponding to one of the plurality of terminals; and
electronically steering a beam of an antenna in response to the addressing information.

2. A method according to claim 1, further comprising:
performing one of a plurality of modulation schemes based upon the addressing information; and
coding the message based upon the addressing information.

3. A method according to claim 1, further comprising:
determining whether a queue among a plurality of queues is available;
selectively storing the received message in the queue based upon the determining step; and
selecting the queue for transmission of the stored message based upon at least one of a timer value corresponding to a delay parameter, and a timeplan.

4. A method according to claim 3, wherein the message is stored based upon the addressing information.

5. A method according to claim 1, wherein the message has a format that conforms with a prescribed communications protocol that includes at least one of Asynchronous Transfer Mode (ATM), Internet Protocol (IP), Ethernet, and Virtual Local Area Network (VLAN).

6. A method according to claim 1, wherein the message in the receiving step includes a prepended tag that specifies information for directing the beam.

7. A method according to claim 1, further comprising:
determining whether a delay value associated with the received message exceeds a predetermined threshold corresponding to a service level agreement (SLA); and
transmitting the message based on the determining step.

8. A method according to claim 1, further comprising:
further receiving another message; and
grouping the messages for transmission if the messages share common addressing information.

9. A method according to claim 1, further comprising:
transmitting the message to the one terminal over a point-to-multipoint communications channel.

10. An apparatus for communicating in a wireless network, the apparatus comprising:
an interface configured to receive a message that contains addressing information corresponding to a terminal within the wireless network;
an antenna having a beam and being configured to transmit the message; and
logic configured to electronically steer the beam of the antenna in response to the addressing information.

11. An apparatus according to claim 10, wherein the logic selects one of a plurality of modulation schemes based upon the addressing information and one of a plurality of coding schemes based upon the addressing information.

12. An apparatus according to claim 10, further comprising:
a plurality of queues coupled to the interface, wherein the logic is configured to determine whether one of the plurality of queues is available, the one queue selectively storing the received message based upon the availability, the one queue being selected for transmission of the stored message based upon at least one of a timer value corresponding to a delay parameter, and a timeplan.

13. An apparatus according to claim 12, wherein the message is stored based upon the addressing information.

14. An apparatus according to claim 10, further comprising:
a switching engine coupled to the interface and configured to route the message, wherein the message has a format that conforms with a prescribed communications protocol that includes at least one of Asynchronous Transfer Mode (ATM), Internet Protocol (IP), Ethernet, and Virtual Local Area Network (VLAN).

15. An apparatus according to claim 10, wherein the received message includes a prepended tag that specifies information for directing the beam.

16. An apparatus according to claim 10, wherein the received message is transmitted based upon determining whether a delay value associated with the received message exceeds a predetermined threshold corresponding to a service level agreement (SLA).

17. An apparatus according to claim 10, wherein the interface receives another message, the messages being grouped for transmission if the messages share common addressing information.

18. An apparatus according to claim 10, wherein the message is transmitted to the terminal over a point-to-multipoint communications channel.

19. An apparatus for communicating in a wireless network, the apparatus comprising:
means for receiving a message that contains addressing information corresponding to a terminal within the wireless network; and
means for electronically steering a beam of an antenna in response to the addressing information.

20. An apparatus according to claim 19, further comprising:
means for performing one of a plurality of modulation schemes based upon the addressing information; and
means for coding the message based upon the addressing information.

21. An apparatus according to claim 19, further comprising:
means for determining whether a queue among a plurality of queues is available;
means for selectively storing the received message in the queue based upon the determination of the availability; and
means for selecting the queue for transmission of the stored message based upon at least one of a timer value corresponding to a delay parameter, and a timeplan.

22. An apparatus according to claim 21, wherein the message is stored based upon the addressing information.

23. An apparatus according to claim 19, wherein the message has a format that conforms with a prescribed communications protocol that includes at least one of Asynchronous Transfer Mode (ATM), Internet Protocol (IP), Ethernet, and Virtual Local Area Network (VLAN).

24. An apparatus according to claim 19, wherein the received message includes a prepended tag that specifies information for directing the beam.

25. An apparatus according to claim 19, further comprising:
means for determining whether a delay value associated with the received message exceeds a predetermined threshold corresponding to a service level agreement (SLA), wherein the message is transmitted based on the determined delay value.

26. An apparatus according to claim 19, wherein the receiving means receives another message, the apparatus further comprising:
means for grouping the messages for transmission if the messages share common addressing information.

27. An apparatus according to claim 19, further comprising:
means for transmitting the message to the one terminal over a point-to-multipoint communications channel.

28. A radio communications system comprising:
a terminal configured to receive a message from a host, the message containing addressing information corresponding to another terminal, the terminal including an antenna having a beam that is electronically steered in response to the addressing information.

29. A system according to claim 28, wherein the terminal transmits the message to the other terminal using one of a plurality of modulation schemes based upon the addressing information and one of a plurality of coding schemes based upon the addressing information.

30. A system according to claim 28, wherein the terminal further comprises:
a plurality of queues; and
logic coupled to the plurality of queues and configured to determine whether one of the plurality of queues is available, the one queue selectively storing the received message based upon the availability, the one queue being selected for transmission of the stored message based upon at least one of a timer value corresponding to a delay parameter, and a timeplan.

31. A system according to claim 30, wherein the message is stored in the queue based upon the addressing information.

32. A system according to claim 28, wherein the terminal further includes a switching engine configured to route the message to the other terminal, wherein the message has a format that conforms with a prescribed communications protocol that includes at least one of Asynchronous Transfer Mode (ATM), Internet Protocol (IP), Ethernet, and Virtual Local Area Network (VLAN).

33. A system according to claim 28, wherein the received message includes a prepended tag that specifies information for directing the beam.

34. An apparatus according to claim 28, wherein the received message is transmitted based upon determining whether a delay value associated with the received message exceeds a predetermined threshold corresponding to a service level agreement (SLA).

35. A system according to claim 28, wherein the terminal receives another message, the messages being grouped for transmission if the messages share common addressing information.

36. A system according to claim 28, wherein the message is transmitted to the other terminal over a point-to-multipoint communications channel.

37. A computer-readable medium carrying one or more sequences of one or more instructions for communicating in a wireless network having a plurality of terminals, the one or more sequences of one or more instructions including instructions which, when executed by one or more processors, cause the one or more processors to perform the steps of:
examining a message that contains addressing information corresponding to one of the plurality of terminals; and
initiating electronic steering of a beam of an antenna in response to the addressing information.

38. A computer-readable medium according to claim 37, wherein the one or more processors further perform the steps of:
selecting one of a plurality of modulation schemes based upon the addressing information; and
selecting one of a plurality of coding schemes based upon the addressing information.

39. A computer-readable medium according to claim 37, wherein the one or more processors further perform the steps of:
determining whether a queue among a plurality of queues is available;
selectively storing the message in the queue based upon the determining step; and
selecting the queue for transmission of the stored message based upon at least one of a timer value corresponding to a delay parameter, and a timeplan.

40. A computer-readable medium according to claim 39, wherein the message is stored based upon the addressing information.

41. A computer-readable medium according to claim 37, wherein the message has a format that conforms with a prescribed communications protocol that includes at least one of Asynchronous Transfer Mode (ATM), Internet Protocol (IP), Ethernet, and Virtual Local Area Network (VLAN).

42. A computer-readable medium according to claim 37, wherein the message in the examining step includes a prepended tag that specifies information for directing the beam.

43. A computer-readable medium according to claim 37, wherein the one or more processors further perform the step of:
determining whether a delay value associated with the message exceeds a predetermined threshold corresponding to a service level agreement (SLA), wherein the message is transmitted based on the determined delay value.

44. A computer-readable medium according to claim 37, wherein the one or more processors further perform the steps of:
examining another message; and
grouping the messages for transmission if the messages share common addressing information.

45. A computer-readable medium according to claim 37, wherein the one or more processors further perform the step of:
initiating transmission of the message to the one terminal over a point-to-multipoint communications channel.
